(19) United States
(12) Patent Application Publication
(10) Pub. No.: US 2018/0004808 A1
(43) Pub. Date: Jan. 4, 2018

(54) META-FACETS FOR SEMANTICALLY-RELATED DIMENSIONS

(71) Applicant: SAP SE, Walldorf (DE)

(72) Inventors: Peter Snowdon, Levallois (FR); Emmanuel Zarpas, Paris (FR)

(21) Appl. No.: 15/200,189

(22) Filed: Jul. 1, 2016

(51) Int. Cl. G06F 17/30

(52) U.S. Cl. CPC G06F 17/30448; G06F 17/30477; G06F 17/30554

(57) ABSTRACT

A system includes reception of a first query, the first query comprising a meta-facet, determination of one or more dimensions associated with the meta-facet, determination of a dimension query for each of the one or more dimensions based on the first query, execution of each of the determined dimension queries to generate a respective result set for each of the determined dimension queries, and presentation of a respective visualization of each of the respective result sets.

### BACKGROUND

Enterprise software systems receive, generate, and store data related to many aspects of a business enterprise. This data may relate to sales, customer relationships, marketing, supplier relationships, inventory, human resources, and/or finances. Users operate reporting tools to access such data and display the data in useful formats, such as graphic visualizations.

Reporting tools may interact with a semantic layer defining a set of abstract entities known as business objects. Each business object associates one or more physical entities (e.g., a physical database table, associated columns of one or more database tables, etc.) of one or more data sources with user-friendly names. Business objects may be classified as dimensions, or facets, along which one may want to perform an analysis or report (e.g., Year, Country, Product), or measures (e.g., Sales, Profit), whose values can be determined for a given combination of dimension values. Some conventional reporting tools receive user-submitted queries including dimensions and measures (e.g., Sales by Country), and, in response, present one or more visualizations (e.g., bar graph, pie chart, geo-chart) of values which respond to the query, with each value being presented in conjunction with facet values to which the value corresponds. In some systems, the visualizations may be modified by filtering the results on facet values.

The instances of a given dimension may appear in one or more data sources. Dimension hierarchies may also present situations in which a name of a sub-dimension of one hierarchy is identical to the name of a sub-dimension of a second hierarchy. If, for example, a City dimension appears in three different data sources, or in three different hierarchies, a query over the City dimension would result in visualizations including three different independent City facets. Moreover, certain dimension values may appear in one or more dimensions (e.g., time values, personal names) and therefore a dimension must be specified when attempting to filter a query based on such a dimension value. Improved systems for managing semantically-similar dimensions are desired.

### BRIEF DESCRIPTION OF THE DRAWINGS

FIG. 1 is a block diagram of a system architecture according to some embodiments.

FIG. 2 illustrates dimensions and dimension values from disparate data sources according to some embodiments.

FIG. 3 illustrates geographic dimension hierarchies according to some embodiments.

FIG. 4 illustrates time dimension hierarchies according to some embodiments.

FIG. 5 illustrates dimensions whose dimension values are personal identifiers according to some embodiments.

FIG. 6 is a flow diagram of process steps according to some embodiments.

FIG. 7 is an outward view of a displayed user interface according to some embodiments.

FIG. 8 is an outward view of a displayed user interface including visualizations according to some embodiments.

FIG. 9 is an outward view of a displayed user interface according to some embodiments.

FIG. 10 is an outward view of a displayed user interface including visualizations according to some embodiments.

FIG. 11 is a flow diagram of process steps according to some embodiments.

FIG. 12 is an outward view of a displayed user interface according to some embodiments.

FIG. 13 is an outward view of a displayed user interface including visualizations according to some embodiments.

FIG. 14 is an outward view of a displayed user interface according to some embodiments.

FIG. 15 is an outward view of a displayed user interface including visualizations according to some embodiments.

FIG. 16 is a block diagram of a computing system according to some embodiments.

### DETAILED DESCRIPTION

The following description is provided to enable any person in the art to make and use the described embodiments. Various modifications, however, will remain readily apparent to those in the art.

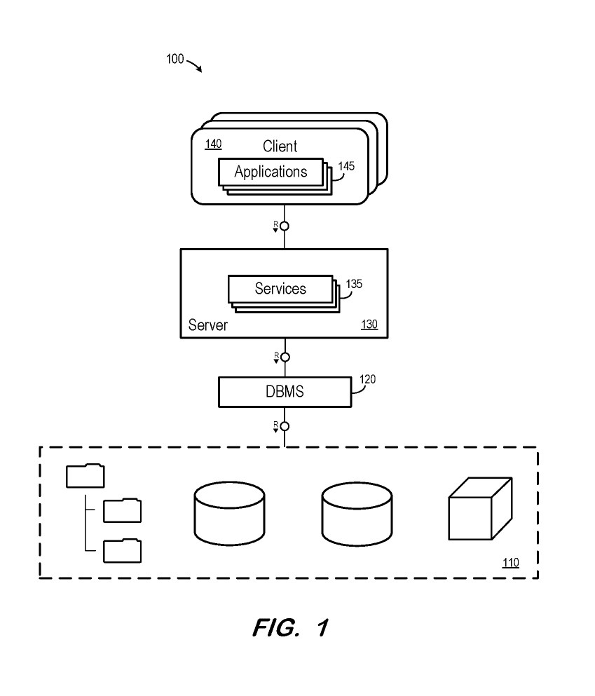

FIG. 1 is a block diagram of architecture 100 according to some embodiments. Embodiments are not limited to architecture 100 or to a database architecture.

Architecture 100 includes data store 110, database management system (DBMS) 120, server 130, services 135, clients 140 and applications 145. Generally, services 135 executing within server 130 receive requests from applications 145 executing on clients 140 and provides results to applications 145 based on data stored within data store 110.

As described above, system 100 includes metadata defining business objects which are mapped to logical entities of data store 110. The metadata be stored in data store 110 and/or a separate repository (not shown). The metadata may include information regarding dimension names (e.g., Country, Year, Product), dimension hierarchies (e.g., Country>State>City), measure names (Profit, Units, Sales), their mappings to respective physical entities (e.g., table columns) of data store 110, and any other suitable metadata.

According to some embodiments, the metadata of system 110 may also define meta-dimensions and meta-facets. As will be used herein, a meta-dimension comprises a union of two or more dimensions which share a common semantic. A meta-facet is an identifier of a meta-dimension, and may be used in a query which is executed as described below. Examples of meta-facets and meta-dimensions will be provided below.

Data store 110 may comprise any data sources which are or become known, including but not limited to database views, spreadsheets, relational databases and/or OnLine Analytical Processing cubes. Each type of data source may require a particular Extract, Transform and Load process in order to store its data within data store 110.

Server 130 may execute and provide services 135 to applications 145. Services 135 may comprise server-side executable program code (e.g., compiled code, scripts, etc.) which provide functionality to applications 145 by providing user interfaces to clients 140, receiving requests from applications 145, retrieving data from data store 110 based on the requests, processing the data received from data store 110, and providing the processed data to applications 145. Services 135 may be made available for execution by server 130 via registration and/or other procedures which are known in the art.

In one specific example, a client 140 executes an application 145 to present a user interface to a user on a display of the client 140. The user enters a query into the user interface consisting of one or more dimensions and/or one or more measures. The query may also include other information such as filters. The application passes a request based on the query to one of services 135. An SQL script is generated based on the request and forwarded to DBMS 120. DBMS 120 executes the SQL script to return a result set based on data of data store 110, and the application 145 creates a report/visualization based on the result set. The report/visualization may be navigable or filterable via facet values of the result set.

Server 130 provides any suitable protocol interfaces through which applications 145 executing on clients 140 may communicate with services 135 executing on application server 130. For example, server 130 may include a HyperText Transfer Protocol (HTTP) interface supporting a transient request/response protocol over Transmission Control Protocol (TCP), and/or a WebSocket interface supporting non-transient full-duplex communications between server 130 and any clients 140 which implement the WebSocket protocol over a single TCP connection.

One or more services 135 executing on server 130 may communicate with DBMS 120 using database management interfaces such as, but not limited to, Open Database Connectivity (ODBC) and Java Database Connectivity (JDBC) interfaces. These types of services 135 may use Structured Query Language (SQL) to manage and query data stored in data store 110.

DBMS 120 serves requests to query, retrieve, create, modify (update), and/or delete data of data store 110, and also performs administrative and management functions. Such functions may include snapshot and backup management, indexing, optimization, garbage collection, and/or any other database functions that are or become known. DBMS 120 may also provide application logic, such as database procedures and/or calculations, according to some embodiments. This application logic may comprise scripts, functional libraries and/or compiled program code.

Server 130 may be separated from or closely integrated with DBMS 120. A closely-integrated server 130 may enable execution of services 135 completely on the database platform, without the need for an additional server. For example, according to some embodiments, server 130 provides a comprehensive set of embedded services which provide end-to-end support for Web-based applications. The services may include a lightweight web server, configurable support for Open Data Protocol, server-side JavaScript execution and access to SQL and SQLScript.

Data store 110 may comprise any query-responsive data source or sources that are or become known, including but not limited to a structured-query language (SQL) relational database management system. Data store 110 may comprise a relational database, a multi-dimensional database, an eXtendable Markup Language (XML) document, or any other data storage system storing structured and/or unstructured data. The data of data store 110 may be distributed among several relational databases, dimensional databases, and/or other data sources. Embodiments are not limited to any number or types of data sources.

In some embodiments, the data of data store 110 may comprise one or more of conventional tabular data, row-based data, column-based data, and object-based data. Moreover, the data may be indexed and/or selectively replicated in an index to allow fast searching and retrieval thereof. Data store 110 may support multi-tenancy to separately support multiple unrelated clients by providing multiple logical database systems which are programmatically isolated from one another.

Data store 110 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Each of clients 140 may comprise one or more devices executing program code of an application 145 for presenting user interfaces to allow interaction with application server 130. The user interfaces of applications 145 may comprise user interfaces suited for reporting, data analysis, and/or any other functions based on the data of data store 110.

Presentation of a user interface as described herein may comprise any degree or type of rendering, depending on the type of user interface code generated by server 130. For example, a client 140 may execute a Web Browser to request and receive a Web page (e.g., in HTML format) from application server 130 via HTTP, HTTPS, and/or WebSocket, and may render and present the Web page according to known protocols. One or more of clients 140 may also or alternatively present user interfaces by executing a standalone executable file (e.g., an .exe file) or code (e.g., a JAVA applet) within a virtual machine. In another method, one of more of clients 140 execute applications 145 loaded from server 130, that receive data and metadata by requests to services 135 executed on the server 130. Data and metadata is processed by the applications 145 to render the user interface on the client 140.

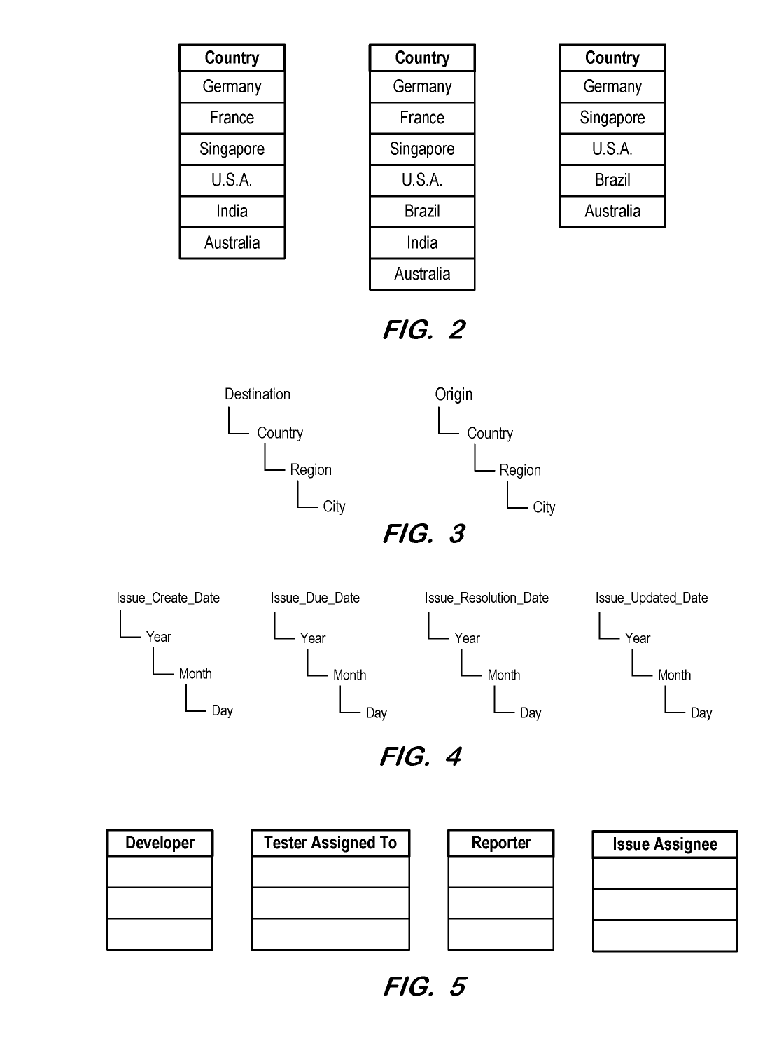

FIG. 2 illustrates table columns of data store 110 according to some embodiments. It will be assumed that each table column of FIG. 2 is stored within a different data source of data store 110, and that the metadata of system 100 associates each table column with an independent Country dimension of the data source in which the column is stored. As described in the Background above, a query of data store 110 over the Country dimension would conventionally return a different facet for each of the three table columns.

A similar issue may arise, even in the case of a single data source, with respect to dimension hierarchies. FIG. 3 illustrates a Destination dimension hierarchy and an Origin dimension hierarchy. The dimensions of these hierarchies share common names, and therefore a query over one of these names must, conventionally, also specify a particular dimension hierarchy. FIG. 4 illustrates hierarchies of time-related dimensions, which present the same challenge as described with respect to FIG. 3. Moreover, specifying a query filter (e.g., U.S.A. or 2010) conventionally requires specification of the dimension hierarchy to which this filter should be applied.

FIG. 5 illustrates another scenario in which semantically-related dimensions present difficulties within conventional systems. Each of the four table columns represent an independent dimension. However, the dimension values of each dimension are personal identifiers (e.g., full names, IDs, etc.), many of which may be shared among the dimensions. Again, as described with respect to FIGS. 3 and 4, conventional systems would require specification of one of these dimensions within a query which includes a dimension value filter (e.g., John Smith).

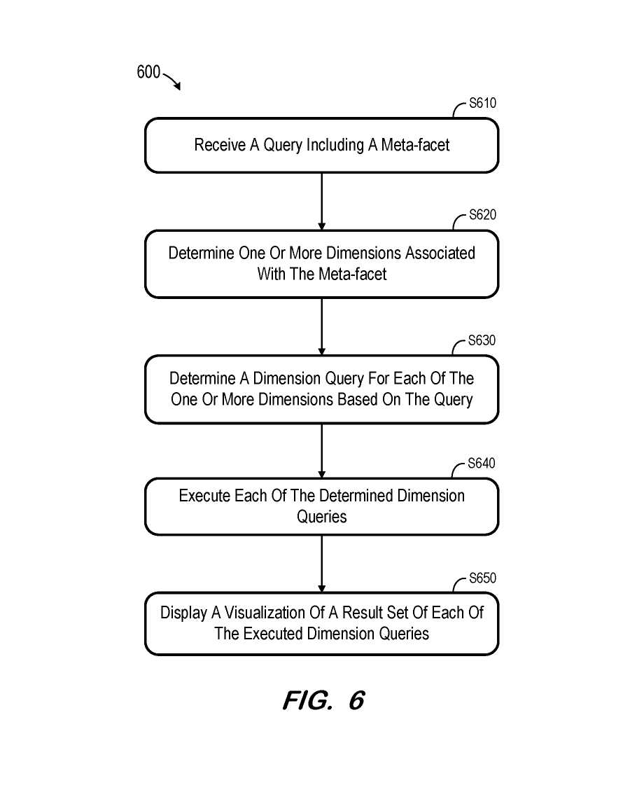

FIG. 6 comprises a flow diagram of process 600 according to some embodiments. In some embodiments, various hardware elements of system 100 execute program code to perform process 600. Process 600 and all other processes mentioned herein may be embodied in computer-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S610, a query is received comprising at least one meta-facet. The query may include one or more dimensions, measure and/or filters. According to some embodiments, a meta-dimension is defined (i.e., specified in metadata of system 100) to include each Country dimension of the system represented in FIG. 2. The list of values of the meta-dimension comprises the distinct union of the lists of values of its constituent dimensions. In the example below, the meta-dimension is identified by the meta-facet Country.

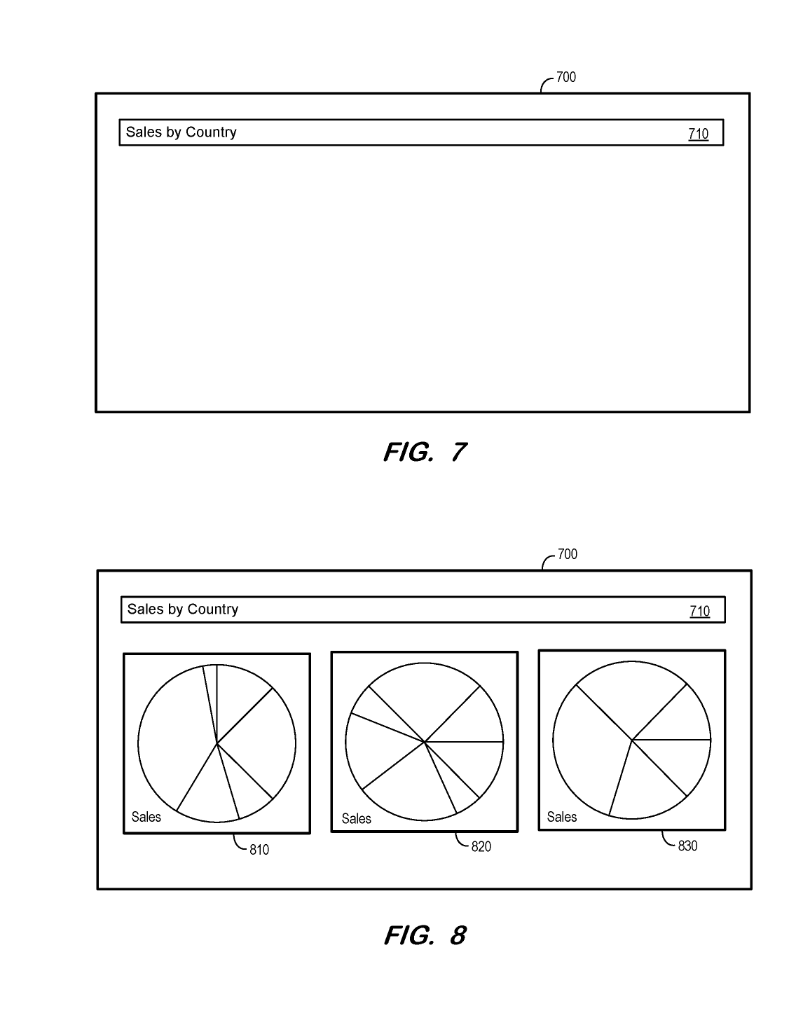

FIG. 7 illustrates interface 700 to receive a query from a user according to some embodiments of S610. Interface 700 may comprise a Web page provided by server 130 in response to a request from a Web browser application 145 executing on client 140. As shown, a user has entered the query “Sales by Country” into input field 310. Any client application 145 may be used to display interface 300, which is not limited to Web-based formats.

Next, at S620, one or more dimensions associated with the meta-facet are determined. As mentioned above, metadata of system 100 may provide an association between meta-facets (e.g., Country) and one or more dimensions (e.g., the three Country dimensions associated with the columns of FIG. 2. According to some embodiments, the query is parsed at S620 to determine whether the query includes any meta-facets. If not, flow then proceeds in a conventional manner to execute the query according to known techniques.

At S630, and based on the received query, a “dimension” query is determined for each of the one or more dimensions determined at S620. In some embodiments, each of the one or more dimensions is substituted for the meta-facet within the query. With respect to the example of FIGS. 7 and 2, three queries are determined at S630, each of which is “Sales by Country”. However, the Country dimension in each query is associated with a respective one of the Country dimensions represented by the FIG. 2 columns.

Each of the determined dimension queries is executed at S640, based on known techniques and on the metadata associations between each of the Country dimensions and their respective table columns. Then, at S650, a visualization of a result set for each executed query is displayed. FIG. 8 illustrates visualizations 810, 820 and 830 according to some embodiments. Each of visualizations 810, 820 and 830 includes a different number of pie “slices”, representing the different number of dimension values of each column of FIG. 2.

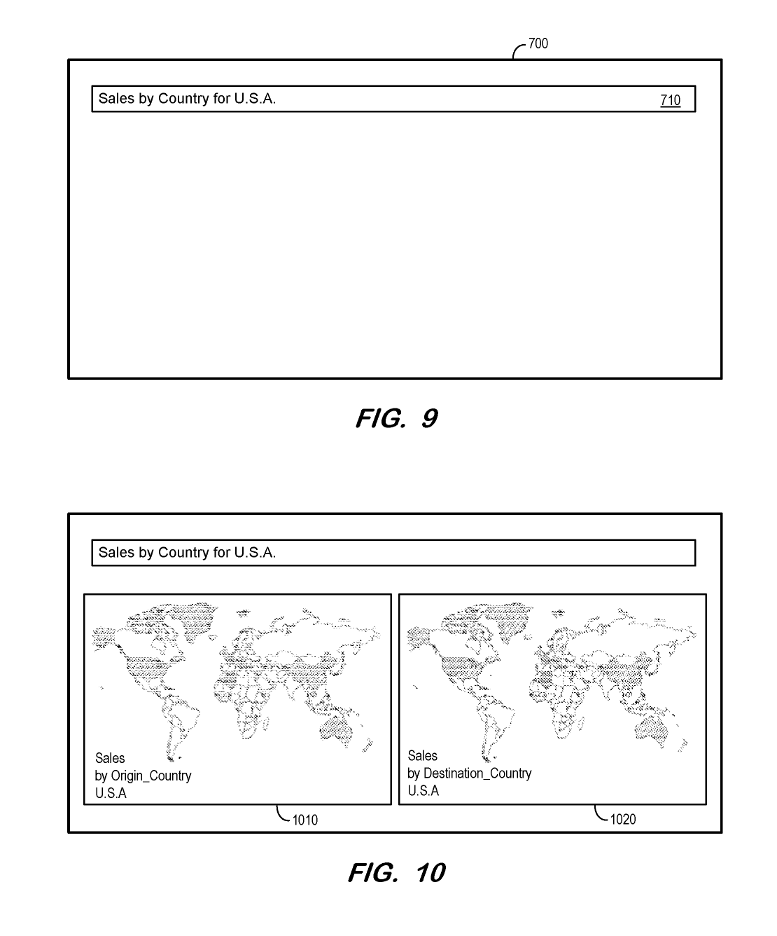

It will now be assumed that the query “Sales by Country for U.S.A.” is received at S610, as illustrated in FIG. 9. Again, at S620, one or more dimensions associated with the meta-facet Country are determined. With respect to FIG. 3, it is determined (based on metadata defining the illustrated hierarchies and associated meta-facets) that the meta-facet Country is associated with the dimensions Origin_Country and Destination_Country.

Based on the received query, a “dimension” query is determined for each of the one or more determined dimensions at S630. With respect to the example of FIGS. 9 and 3, two queries are determined at S630; “Sales by Origin_Country for U.S.A.”; and “Sales by Destination_Country for U.S.A.”.

Each of the determined dimension queries is executed at S640, based on known techniques and on the metadata associations between the Origin_Country and Destination_Country dimensions and their respective table columns. A visualization of a result set for each executed query is displayed at S650. FIG. 10 illustrates visualizations 1010 and 1020 presented at S650 according to some embodiments. Visualizations 1010 and 1020 indicate the specific dimensions with which they are associated.

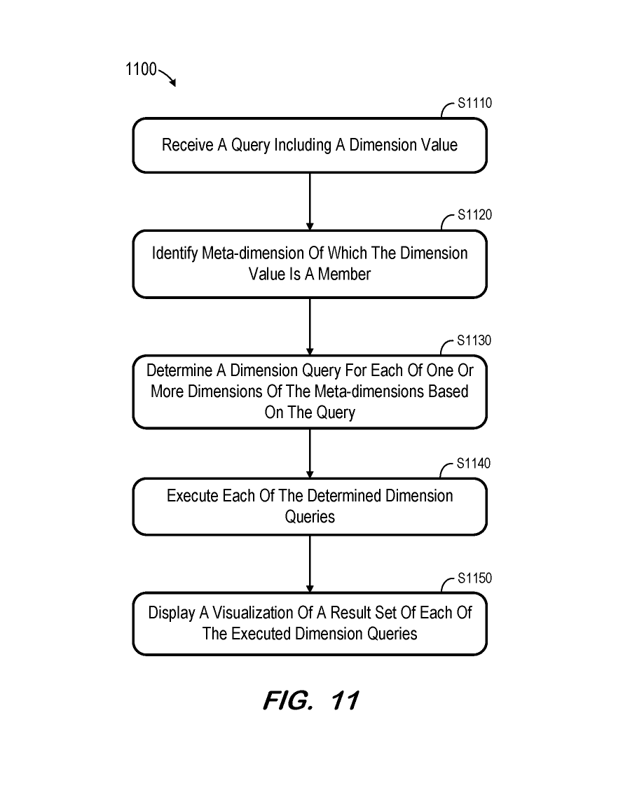

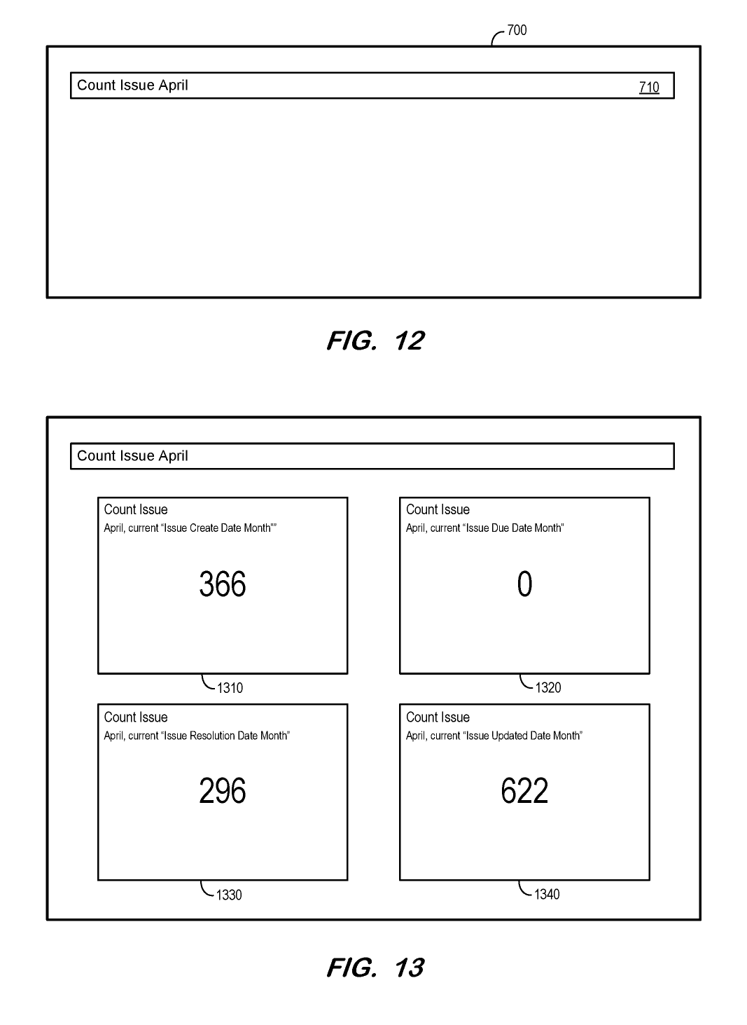

FIG. 11 illustrates process 1100 describing another usage of meta-facets according to some embodiments. A query including a dimension value is received at S1110. In the FIG. 12 example, the query is “Count Issue April”, and the dimension value is “April”.

A meta-dimension including the dimension value is identified at S1120. As described above, a meta-dimension is a set of dimensions and the values of the meta-dimension comprise a union of distinct values of its constituent dimensions. With respect to the example of FIG. 4, it is determined at S1120 that the dimension value April is a member of a meta-dimension consisting of the dimensions Issue_Create_Date_Month, Issue_Due_Date_Month, Issue_Resolution_Date_Month, and Issue_Updated_Date_Month.

A dimension query is then determined at S1130 for each dimension of the identified meta-dimension. Continuing the present example, the queries determined at S1130 are: Count Issue April as Issue_Create_Date_Month; Count Issue April as Issue_Due_Date_Month; Count Issue April as Issue_Resolution_Date_Month; and Count Issue April as Issue_Updated_Date_Month.

The dimension queries are executed at S1140 and a visualization of each result set is displayed at S1150. FIG. 13 illustrates a visualizations 1310-1340 of result sets for each of the queries mentioned above. Advantageously, the user is not required to specify a dimension within a query which would have been ambiguous to prior systems.

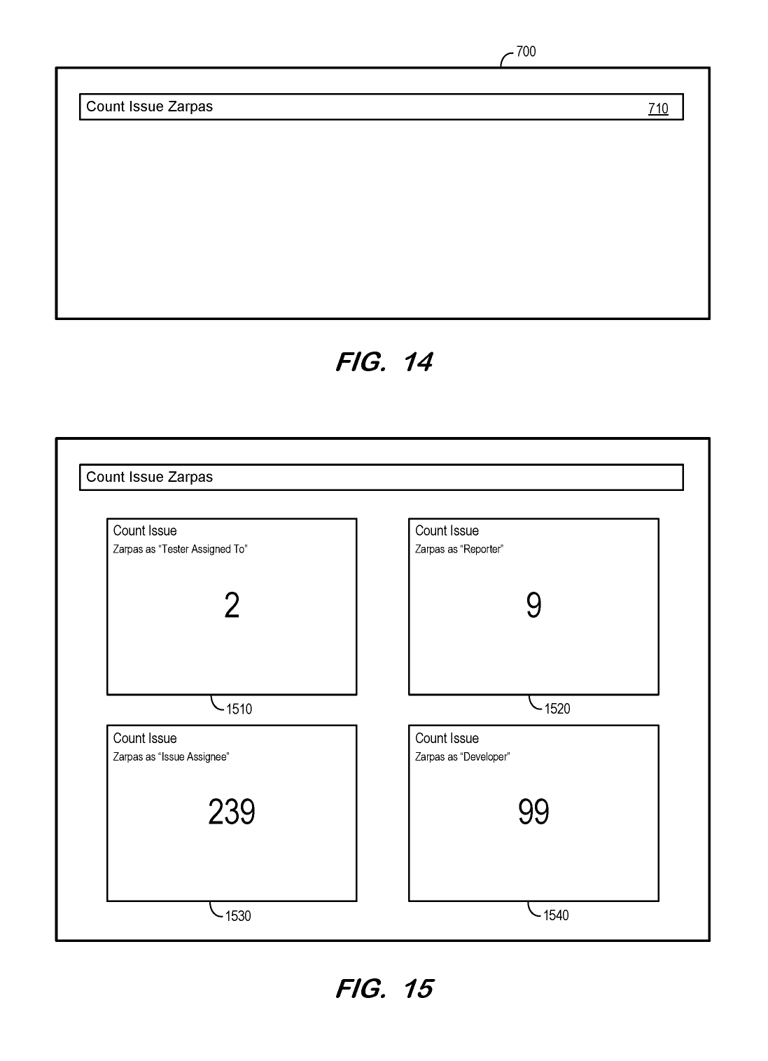

FIG. 14 illustrates reception of the query is “Count Issue Zarpas” at S1110. In this example, the dimension value of the query is “Zarpas”. A meta-dimension including the dimension value is identified at S1120. Turning to the example of FIG. 5, it is determined at S1120 that the dimension value Zarpas is a member of a meta-dimension consisting of the dimensions “Tester Assigned To”, “Reporter”, “Issue Assignee” and “Developer”.

A dimension query is determined at S1130 for each dimension of the identified meta-dimension. With respect to the present example, the queries determined at S1130 are: Count Issue Zarpas as Tester Assigned To, Count Issue Zarpas as Reporter, Count Issue Zarpas as Issue Assignee and Count Issue Zarpas as Developer. The dimension queries are executed at S1140 and a visualization of each result set is displayed at S1150, as illustrated by visualizations 1510-1540 of FIG. 15.

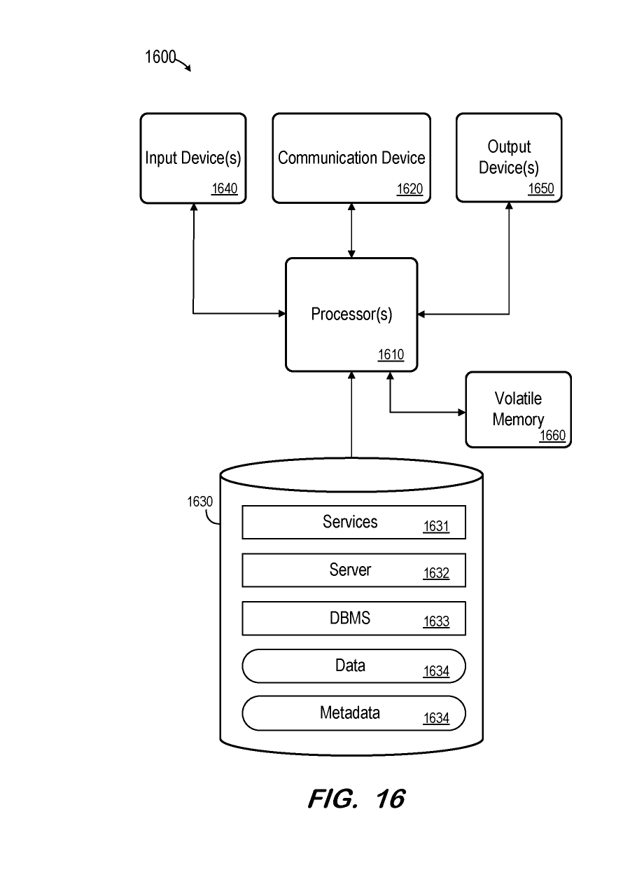

FIG. 16 is a block diagram of apparatus 1600 according to some embodiments. Apparatus 1600 may comprise a general-purpose computing apparatus and may execute program code to perform any of the functions described herein. Apparatus 1600 may comprise an implementation of server 130, DBMS 120 and data store 110 of FIG. 1 in some embodiments. Apparatus 1600 may include other unshown elements according to some embodiments.

Apparatus 1600 includes processor(s) 1610 operatively coupled to communication device 1620, data storage device 1630, one or more input devices 1640, one or more output devices 1650 and memory 1660. Communication device 1620 may facilitate communication with external devices, such as a reporting client, or a data storage device. Input device(s) 1640 may comprise, for example, a keyboard, a keypad, a mouse or other pointing device, a microphone, knob or a switch, an infra-red (IR) port, a docking station, and/or a touch screen. Input device(s) 1640 may be used, for example, to enter information into apparatus 1600. Output device(s) 1650 may comprise, for example, a display (e.g., a display screen) a speaker, and/or a printer.

Data storage device 1630 may comprise any appropriate persistent storage device, including combinations of magnetic storage devices (e.g., magnetic tape, hard disk drives and flash memory), optical storage devices, Read Only Memory (ROM) devices, etc., while memory 1660 may comprise Random Access Memory (RAM), Storage Class Memory (SCM) or any other fast-access memory.

Services 1631, server 1632 and DBMS 1633 may comprise program code executed by processor 1610 to cause apparatus 1600 to perform any one or more of the processes described herein. Embodiments are not limited to execution of these processes by a single apparatus.

Data 1634 and metadata 1635 (either cached or a full database) may be stored in volatile memory such as memory 1660. Metadata 1635 may include information regarding dimension names, dimension hierarchies, dimension values, meta-facets, meta-dimensions, and measures. Data storage device 1630 may also store data and other program code for providing additional functionality and/or which are necessary for operation of apparatus 1600, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable process steps; and
a processor to execute the processor-executable process steps to cause the system to:
receive a first query, the first query comprising a meta-facet;
determine one or more dimensions associated with the meta-facet;
determine a dimension query for each of the one or more dimensions based on the first query;
execute each of the determined dimension queries to generate a respective result set for each of the determined dimension queries; and
present a respective visualization of each of the respective result sets.

2. A system according to claim 1, the processor to further execute the processor-executable process steps to cause the system to:
receive a second query;
determine that the second query does not comprise a meta-facet;
execute the second query to generate a second result set; and
present a second visualization of the second result set.

3. A system according to claim 1, the processor to further execute the processor-executable process steps to cause the system to:
receive a second query, the second query comprising a second meta-facet;
determine a second one or more dimensions associated with the second meta-facet;
determine a second dimension query for each of the second one or more dimensions based on the second query;
execute each of the determined second dimension queries to generate a respective second result set for each of the determined second dimension queries; and
present a respective visualization of each of the respective second result sets.

4. A system according to claim 3, the processor to further execute the processor-executable process steps to cause the system to:
receive a third query, the third query comprising a dimension value;
identify a meta-dimension of which the dimension value is a member;
determine a third dimension query for each of one or more dimensions of the meta-dimension based on the third query;
execute each of the third determined dimension queries to generate a respective third result set for each of the third determined dimension queries; and
present a respective third visualization of each of the respective third result sets.

5. A system according to claim 1, the processor to further execute the processor-executable process steps to cause the system to:
receive a second query, the second query comprising a dimension value;
identify a meta-dimension of which the dimension value is a member;
determine a second dimension query for each of one or more dimensions of the meta-dimension based on the second query;
execute each of the second determined dimension queries to generate a respective second result set for each of the second determined dimension queries; and
present a respective second visualization of each of the respective second result sets.

6. A computer-implemented method comprising:
receiving a query, the query comprising a dimension value;
identifying a meta-dimension of which the dimension value is a member;
determining a dimension query for each of one or more dimensions of the meta-dimension based on the query;
executing each of the determined dimension queries to generate a respective result set for each of the determined dimension queries; and
presenting a respective visualization of each of the respective result sets.

7. A method according to claim 6, further comprising:
receiving a second query, the second query comprising a meta-facet;
determining a second one or more dimensions associated with the meta-facet;
determining a second dimension query for each of the second one or more dimensions based on the second query;
executing each of the determined second dimension queries to generate a respective second result set for each of the determined second dimension queries; and
presenting a respective second visualization of each of the respective second result sets.

8. A method according to claim 7, further comprising:
receiving a third query;
determining that the third query does not comprise a meta-facet;
executing the third query to generate a third result set; and
presenting a third visualization of the third result set.

9. A method according to claim 6, further comprising:
receiving a second query, the query comprising a second dimension value;
identifying a second meta-dimension of which the second dimension value is a member;
determining a second dimension query for each of one or more second dimensions of the second meta-dimension based on the query;
executing each of the determined second dimension queries to generate a respective second result set for each of the determined second dimension queries; and
presenting a respective second visualization of each of the respective second result sets.

10. A method according to claim 9, further comprising:
receiving a third query, the third query comprising a meta-facet;
determining a third one or more dimensions associated with the meta-facet;
determining a third dimension query for each of the third one or more dimensions based on the third query;
executing each of the determined third dimension queries to generate a respective third result set for each of the determined third dimension queries; and
presenting a respective third visualization of each of the respective third result sets.

11. A non-transitory computer-readable medium storing program code, the program code executable by a processor of a computing system to cause the computing system to:
receive a first query, the first query comprising a meta-facet;
determine one or more dimensions associated with the meta-facet;
determine a dimension query for each of the one or more dimensions based on the first query;
execute each of the determined dimension queries to generate a respective result set for each of the determined dimension queries; and
present a respective visualization of each of the respective result sets.

12. A medium according to claim 11, the program code further executable by a processor of a computing system to cause the computing system to:
receive a second query;
determine that the second query does not comprise a meta-facet;
execute the second query to generate a second result set; and
present a second visualization of the second result set.

13. A medium according to claim 11, the program code further executable by a processor of a computing system to cause the computing system to:
receive a second query, the second query comprising a second meta-facet;
determine a second one or more dimensions associated with the second meta-facet;
determine a second dimension query for each of the second one or more dimensions based on the second query;
execute each of the determined second dimension queries to generate a respective second result set for each of the determined second dimension queries; and
present a respective visualization of each of the respective second result sets.

14. A medium according to claim 13, the program code further executable by a processor of a computing system to cause the computing system to:
receive a third query, the third query comprising a dimension value;
identify a meta-dimension of which the dimension value is a member;
determine a third dimension query for each of one or more dimensions of the meta-dimension based on the third query;
execute each of the third determined dimension queries to generate a respective third result set for each of the third determined dimension queries; and
present a respective third visualization of each of the respective third result sets.

15. A medium according to claim 11, the program code further executable by a processor of a computing system to cause the computing system to:
receive a second query, the second query comprising a dimension value;
identify a meta-dimension of which the dimension value is a member;
determine a second dimension query for each of one or more dimensions of the meta-dimension based on the second query;
execute each of the second determined dimension queries to generate a respective second result set for each of the second determined dimension queries; and
present a respective second visualization of each of the respective second result sets.
